(19) United States
(12) Patent Application Publication
(10) Pub. No.: US 2008/0267411 A1
(43) Pub. Date: Oct. 30, 2008

(54) Method and Apparatus for Enhancing Security of a Device

(75) Inventors: Petr Peterka, San Diego, CA (US); Alexander Medvinsky, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/773,115

(22) Filed: Jul. 3, 2007

Related U.S. Application Data
(60) Provisional application No. 60/914,446, filed on Apr. 27, 2007.

(51) Int. Cl. H04L 9/08

(52) U.S. Cl. 380/279

(57) ABSTRACT

A method is provided that authenticates a data transfer module. Further, the method establishes a secure tunnel between a first processor, which receives a copy protection key from the data transfer module, and a second processor, which receives the copy protection key from the first processor through the secure tunnel. In addition, the method receives, at the second processor, encrypted content from the data transfer module. The method also decrypts, at the second processor, the encrypted content with the copy protection key to generate decrypted content.

This application claims priority to the filing date of a U.S. provisional patent application, having Ser. No. 60/914,446, entitled “SYSTEM AND METHOD FOR IMPLEMENTING LOCATION-BASED CONTENT RESTRICTIONS IN A MOBILE VIDEO BROADCAST ENVIRONMENT”, filed on Apr. 27, 2007, which is incorporated herein by reference in its entirety.

### BACKGROUND

1. Field

This disclosure generally relates to the field of audio/visual content. More particularly, the disclosure relates to security for a device that stores audio/visual content.

2. General Background

Content providers, e.g., cable providers, have conventionally utilized a cable line for transmission of audio/visual content to a set top box that is connected to a television in a user's home. Recent developments have led to a CableCARD®, which is basically a smart card that that has an input to receive the cable from the content provider. Further, the CableCARD® may then be directly inserted into a slot in the television to directly receive the content from the cable provider, without the need for a set top box. However, current limitations of the CableCARD® have prevented the elimination of the set top box. For instance, the current implementation of the CableCARD® has a one-way configuration to only receive content, which thereby prevents a user from ordering on demand or pay-per-view content that is possible in the two-way configuration of the set top box. Further, older televisions may not have a slot for the CableCARD®. Accordingly, a set top box may be configured with a slot to receive the CableCARD® so that the security of the audio visual content distributed from the content provider is separated from the security of the set top box.

Most set top box environments are configured to be conditional access (“CA”) systems, which only allow access of the audio/visual content to an authorized user. An encryption mechanism is normally utilized to implement the CA. As a result, copy protection (“CP”) is ensured so that an unauthorized user is prevented from making a copy of the audio/visual content. However, the introduction of the CableCARD® has raised security concerns regarding the transfer of content from the CableCARD® to the set top box.

### SUMMARY

In one aspect of the disclosure, a method is provided. The method authenticates a data transfer module. Further, the method establishes a secure tunnel between a first processor, which receives a copy protection key from the data transfer module, and a second processor, which receives the copy protection key from the first processor through the secure tunnel. In addition, the method receives, at the second processor, encrypted content from the data transfer module. The method also decrypts, at the second processor, the encrypted content with the copy protection key to generate decrypted content.

In another aspect of the disclosure, a method is provided. The method authenticates a data transfer module through an interface connected to the data transfer module. Further, the method establishes a secure tunnel between a communication processor and an audio/visual processor. In addition, the method receives, at the audio/visual processor, a copy protection key from the data transfer module. The method sends the copy protection key, through the secure tunnel, from the audio/visual processor to the communication processor. Further, the method receives, at the communication processor, encrypted content from the data transfer module through the interface. Finally, the method decrypts, at the communication processor, the encrypted content with the copy protection key to generate decrypted content.

In yet another aspect of the disclosure, a method is provided. The method authenticates a set top box through an interface. Further, the method sends a copy protection key to a first processor that is positioned in the set top box. In addition, the method sends encrypted content through the interface to a second processor that is positioned in the set top box and communicates with the first processor through a secure tunnel to obtain the copy protection key for decryption of the encrypted content.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a set top box configuration environment.

FIG. 2A illustrates a configuration in which the A/V processor is responsible for the interface and establishment of a secure session with the data transfer module.

FIG. 2B illustrates an alternative configuration in which the communication processor is responsible for the interface and establishment of a secure session with the data transfer module.

FIG. 3 illustrates a process that enhances the security of the set top box shown in FIG. 1.

FIG. 4 illustrates another process that enhances the security of the set top box shown in FIG. 1.

FIG. 5 illustrates a process that enhances the security of the data transfer module that is utilized in conjunction with the set top box shown in FIG. 1.

FIG. 6 illustrates a block diagram of a station or system that enhances the security of a set top box.

### DETAILED DESCRIPTION

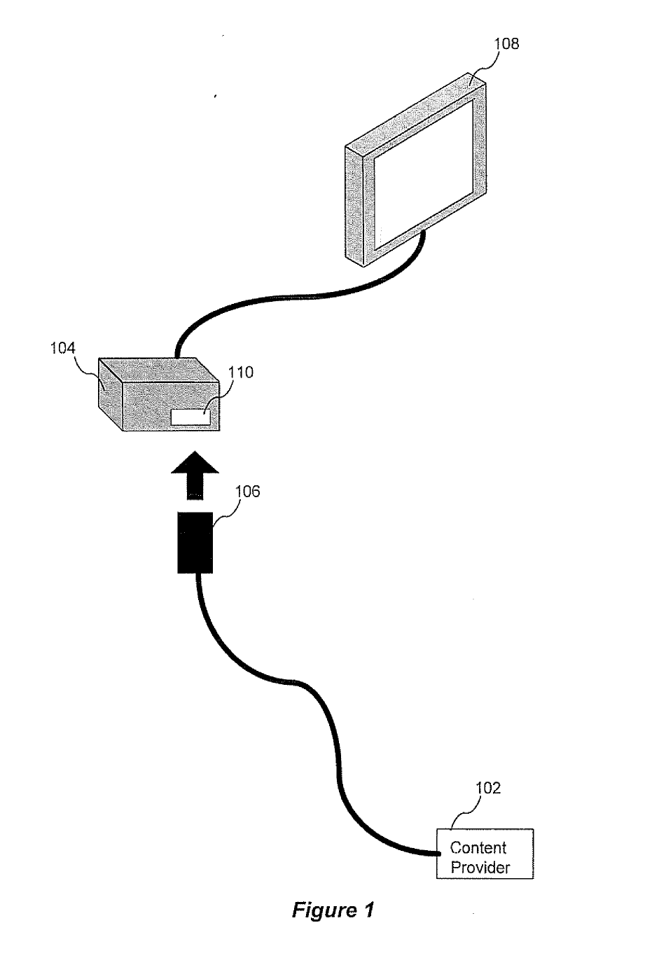

A method and apparatus are disclosed that enhance the security of a set top box with a multi-chip architecture. FIG. 1 illustrates a set top box configuration environment 100. A content provider 102 encrypts a set of content and then sends the content through a transmission line, e.g., a cable, to a data transfer module 106. Examples of the data transfer module include a CableCARD®, smart card, on-board security chip, etc. However, any component that has the capability of terminating conditional access that was protecting content transmitted to a set top box 104 and applying copy protection when sending the content to the set to box 104 may be considered a data transfer module 106. The set top box 104 is utilized as en example, and one of ordinary skill in the art will recognize that any type of device, such as a mobile phone, television with a built-in slot for a CableCARD®, etc., may be utilized. The data transfer module 106 then decrypts the content. Further, the data transfer module 106 has an interface so that it may fit into a slot 110 of a set top box 104 and communicate with the set top box 104. However, the data transfer module 106 does not send the decrypted content to the set top box 104 through the interface because the communication of the decrypted content would be insecure. A copy of the content could potentially be made at the interface. Accordingly, the data transfer module 106 encrypts the decrypted content for transmission to the set top box 104. The data transfer module 106 then sends the encrypted content to the set top box 104. The method and apparatus provide a robust approach for the set top box 104 to decrypt the encrypted content received from the data transfer module 106 and re-encrypt the content so that the content cannot be copied off of a hard drive associated with the set top box 104 if the set top box 104 stores the content, e.g., if the set top box has a Personal Video Recorder (“PVR”). The content may then be decrypted by the set top box 104 and sent to a display 108, e.g., a television, a monitor, etc., for viewing. Re-encryption is also utilized when the content is not recorded, but displayed directly, so that clear content is prevented from being transferred between chips in an unprotected manner.

In one embodiment, the set top box 104 may have one or more additional connections other than to the content provider 102 to allow for the reception of additional content. For instance, the set top box 104 may have a broadband connection to receive content from the Internet. For instance, the set top box 104 may allow a user to download a movie from an Internet provider rather than the content provider 102, e.g., a cable content provider.

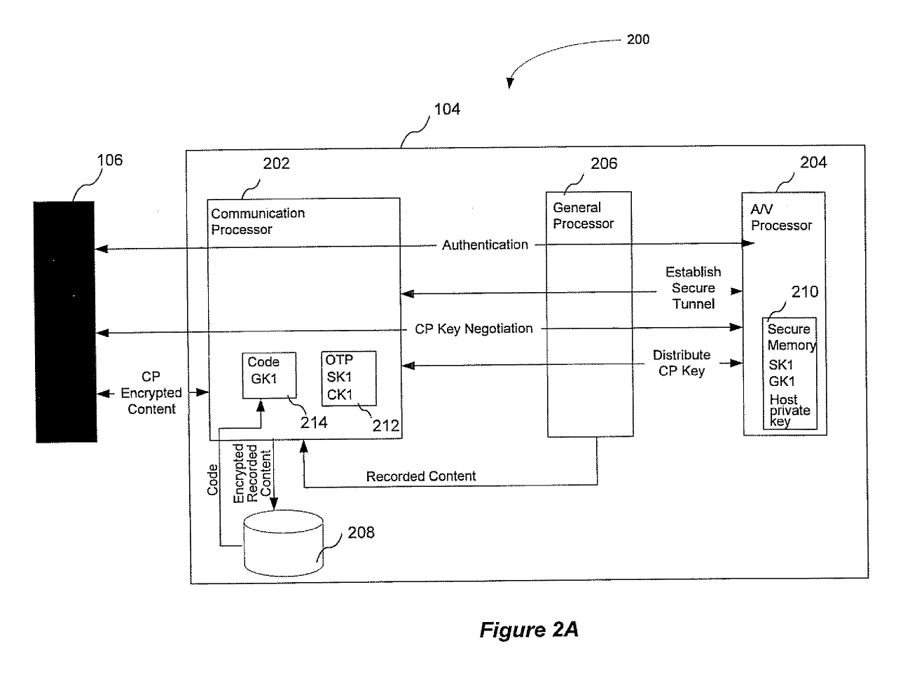

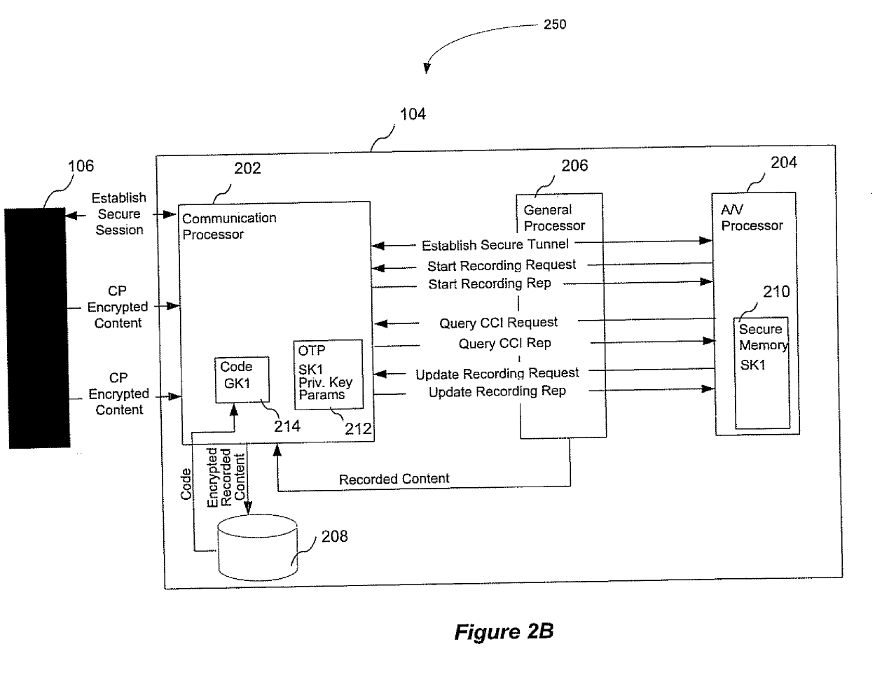

FIG. 2A illustrates a configuration 200 in which the A/V processor 204 is responsible for the interface and establishment of a secure session with the data transfer module 106. In one embodiment, the set top box 104 is capable of performing a plurality of different functions, e.g., receiving content, decrypting the content, decrypting and re-encrypting the decrypted content, processing content from different content providers, etc. Accordingly, the set top box 104 has a multi-chip architecture to allow for this multi-functionality in an optimal manner. Therefore, the set top box 104, may have a plurality of processors. For instance, the set top box 104 may have a communication processor 202, an A/V processor 204, and a general processor 206. Further, the set top box 104 may have a storage device 208, e.g., a hard drive, a memory, etc., to store the content.

The communication processor 202 is a processor that processes an incoming stream of video from the data transfer module 106. The communication processor 202 is able to decrypt the content received by the set top box 104 from the data transfer module 106. However, the communication processor 202 has limited security features. While the communication processor 202 may embed a secret key, the communication processor 202 is not a secure processor that has the capability of establishing the secret key in a trusted environment.

The A/V processor 204 is a video processor that has robust security features. In other words, the A/V processor 204 is a secure processor that may establish a key securely. The A/V processor 204 stores a key in the silicon of the chip utilized for the processor. Accordingly, the key cannot be retrieved to make a copy of content. Therefore, the A/V processor 204 is utilized to establish a key so that the communication processor 202 may encrypt and/or decrypt content that may be recorded by the general processor 206, e.g., with a PVR feature, on a hard drive 208 within or connected to the set top box 104. The recorded content then cannot be copied from the hard drive 208 in a usable format.

In one embodiment, the communication processor 202 and the A/V processor 204 communicate in order to provide a robust form of copy protection for the content received form the data transfer module 106. Further, the communication processor 202 and the A/V processor 204 may communicate through the general processor 206, which basically passes through information between the communication processor 202 and the A/V processor 204. In an alternative embodiment, the communication processor 202 and the A/V processor 204 may communicate directly with one another.

Because the communication processor 202 may not be trusted, the communication processor 202 is only given a minimum set of keys, e.g., the CP key, which change frequently. Other keys that are more important are stored in the A/V processor 204.

Secure communication is established between the communication processor 202 and the A/V processor 204. The communication processor 202 may then decrypt copy-protected content received from the data transfer module 106 and also re-encrypt the decrypted copy-protected content when the re-encrypted copy-protected content is to be recorded by the general processor for storage on the hard drive 208.

Initially, the data transfer module 106 and the set top box 104 authenticate one another prior to the transfer of content. The A/V processor 204 authenticates the set top box 104 to the data transfer module 106, and the data transfer module 106 authenticates itself to the A/V processor 104. The authentication may involve the communication of data that is passed through the communication processor 202 and the general processor 206. In one embodiment, the authentication involves a review by the A/V processor 204 of a digital certificate belonging to the data transfer module 106 and a review by the data transfer module 106 of a digital certificate belonging to the set top box 104 through the A/V processor 204 to establish mutual trustworthiness. Further, the A/V processor 204 stores a host private key, i.e., a private key for the set top box 104 utilized in the authentication of the data transfer module 106, in the secure memory 210. The Digital Rights Management (“DRM”) system executing on the A/V processor 204 will generate a PVR content key, i.e., a unique encryption key for each piece of content to be recorded or played, and will pass it to the communication processor 202 to be utilized in the re-encryption process. Further, the A/V processor 204 sends the PVR content key to the communication processor 202, which re-encrypts decrypted content with the PVR content key and stores the re-encrypted content on the hard drive 208.

Once mutual trustworthiness between the data transfer module 106 and the set top box 104 is established, a CP key is negotiated between the data transfer module 106 and the set top box 104 so that content can be securely transferred from the data transfer module 106 to the set top box 104. The CP key will be the key that the data transfer module 106 utilizes to encrypt the content transmitted from the content provider 102 (shown in FIG. 1). Further, the CP key will be the key that the communication processor 202 utilizes to decrypt the encrypted content received from the data transfer module 106. As the A/V processor 204 is trusted, the A/V processor 204 receives the CP key from the data transfer module 106 in a secure manner for the set top box 104. The CP key is encrypted and authenticated with higher level keys by the data transfer module 106, and the communication processor 202 is not trusted enough to receive the higher level keys, i.e., the higher level keys may be leaked by the less secure communication processor 202. Accordingly, sending the CP key first to the A/V processor 204, which is trusted, avoids exposing the higher level keys to the communication processor 202, which is not trusted. The A/V processor 204 securely negotiates the CP key with the data transfer module 106 and securely transmits the CP key to the A/V processor 204 through a secure tunnel.

Accordingly, after the authentication, a secure tunnel is established between the communication processor 202 and the A/V processor 204. The secure tunnel is a set of encrypted and/or digitally signed messages. In one embodiment, the secure tunnel may go through the general processor 206. In an alternative embodiment, the secure tunnel goes directly between the communication processor 202 and the A/V processor 204.

The communication processor 202 and the A/V processor 204 are preloaded with a shared symmetric key (“SK1”) so that the secure tunnel may be established. For instance, the communication processor 202 and the A/V processor 204 may be preloaded in the factory with the SK1. The SK1 may be stored in the One-Time Programmable (“OTP”) memory 212 of the communication processor 202 and the secure memory 210 of the A/V processor 204. The A/V processor 204 may encrypt a message, which contains the CP key, with the SK1. The encrypted message is an instance of the secure tunnel. Once the A/V processor 204 sends the encrypted message to the communication processor 202, the communication processor 202 may utilize the SK1 to decrypt the encrypted message to obtain the CP key.

A global key (“GK1”) is also utilized in the procedure for establishing the secure tunnel. In one embodiment, the GK1 is hard coded in code 214 that is loaded on to the communication processor 202. The code 214 is encrypted so that the GK1 is secure in the communication processor 202. Further, the GK1 is stored in the secure memory 210 of the A/V processor 204. Once the code 214 is decrypted, the A/V processor 204, which has a trusted environment, can verify the authenticity of code 214 in the communication processor 202 by determining if a match exists between the GK1 stored in the secure memory 210 of the A/V processor 204 and the GK1 hard coded in the code 214 loaded on to the communication processor 202. The code 214 is encrypted utilizing a code encryption key (“CK1”), which is placed on the silicon of the chip on which the communication processor 202 is positioned during the manufacturing process in the factory. Accordingly, the CK1 cannot be retrieved from the chip by an intruder. The communication processor 202 utilizes the CK1 to decrypt the code 214 before loading the code 214 to its internal memory. Since the code 214 is not decrypted while on the hard drive 208, an intruder is unable to retrieve the unencrypted code. Further, if an intruder attempts to load unencrypted code on to the communication processor 202, the unencrypted code will not have the GK1 key. Each time a secure tunnel is established, a session key is derived from the SK1 and the GK1. The session key is utilized for the secure transmission of messages through the secure tunnel.

In one embodiment, once the secure tunnel is established, the A/V processor 204 negotiates the CP key with the data transfer module 106. In another embodiment, the A/V processor 204 may negotiate the CP key with the data transfer module 106 prior to establishing the secure tunnel.

After the establishment of the secure tunnel and receiving the CP key, the A/V processor 204 may then distribute the CP key through the secure tunnel to the communication processor 202. The communication processor 202 may then receive the CP encrypted content from the data transfer module 106 and decrypt the CP encrypted content. Further, the communication processor 202 may receive a set of copy control information (“CCI”) from the data transfer module 106. The CCI provides information as to the types of operations that are allowed on the transferred content. For instance, the CCI may include information such as whether the user is authorized to make a copy, and if so, how many copies. The communication processor 202 utilizes the secure tunnel to communicate the CCI changes to the A/V processor 204 running the DRM system. In response, the A/V processor 204 generates a new set of unique encryption keys to be applied by the communication processor 202 during the re-encryption process and sends them utilizing the secure tunnel back to the communication processor 202. This ensures that CCI values are cryptographically bound to the encrypted content.

In one embodiment, two communication processors 202 may be utilized. One of the two communication processors 202 performs the CP decryption operation in a slave mode while the other is in a master mode to communicate with the data transfer module 106 and provide the CP key. In an alternative embodiment, both communication processors 202 establish a secure tunnel with the A/V processor 204 and act in a slave mode. They may utilize the same SK1 or may each have an SK, e.g., the first communication processor utilizes SK1 and the second communication processor utilizes SK2.

FIG. 2B illustrates an alternative configuration 250 in which the communication processor 202 is responsible for the interface and establishment of a secure session with the data transfer module 106. Accordingly, the communication processor 202, rather than the A/V processor 204, authenticates the data transfer module 106. Further, the communication processor 202 may decrypt and forward an A/V stream, e.g., an MPEG-2 transport stream, for the purpose of recording to the hard drive 208 or to a hard drive associated with the general processor 206.

The communication processor 202 establishes a secure session with the data transfer module 106. In other words, the communication processor 202, rather than the A/V processor 204, is responsible for authenticating the set top box 104 to the data transfer module 106 and authenticating the data transfer module. Accordingly, the data transfer module reviews a digital certificate of the set top box 104 sent by the communication processor 202, and the communication processor reviews a digital certificate sent data transfer module 106. Further, the A/V processor 204 establishes a secure tunnel, which is encrypted and authenticated, with the communication processor 202. The establishment of the secure tunnel may be initiated by the A/V processor 204 prior to the establishment of the secure session with the data transfer module 106, i.e., prior to the connection of the data transfer module 106 to the set top box 104. The A/V processor 204 may request that a program be recorded by the communication processor 202 on the hard drive 208. Further, the A/V processor 204 includes a PVR content key in the request. Accordingly, the communication processor 202 re-encrypts decrypted content with the PVR content key and stores the re-encrypted content on the hard drive 208. In addition, the A/V processor 204 asynchronously listens to CCI updates, i.e., receives the CCI updates through the secure tunnel from the communication processor 202 as opposed to directly from the data transfer module 106, and provides the communication processor 202 with the updated PVR encryption keys. Accordingly, the communication processor 202 utilizes the updated PVR encryption keys to record the subsequent re-encrypted content.

The secure tunnel is established by utilizing the SK1 to encrypt messages between the A/V processor 204 and the communication processor 202. The SK1 is encrypted utilizing the GK1. Unlike the configuration 200, the configuration 250 stores the GK1 only in the communication processor 202. Further, the private key stored in the OTP 212 of the communication processor 202 is utilized by the communication processor 202 to encrypt messages and communicate with the data transfer module 106. Without the correct GK1, the communication processor 202 is unable to establish a secure tunnel with the A/V processor 202. Further, without the correct private key, the communication processor 202 would be unable to communicate with the data transfer module 106. The OTP 212 may also store a variety of other parameters, e.g., Dynamic Feedback Arrangement Scrambling Technique (“DFAST”) parameters.

While the GK1 is utilized to encrypt the private key, the SK1, and other permanent keys in the communication processor 202, a device-unique key may be utilized to double-encrypt all of those values. The device-unique key is unique to the particular set top box 104. Accordingly, copying the encrypted keys to another device will be ineffective as another device will have a different device unique key. Further, encrypting the GK1 with the device-unique key indirectly authenticates the code 214. The GK1 is in the encrypted code image. If an intruder attempts to replace the code 214 with a different set of code not having the GK1, the intruder will not be able to access any of the stored keys.

In one embodiment, the secure tunnel keys utilized between the communication processor 202 and the A/V processor 204 are derived from SK1, a shared secret derived through a key agreement algorithm, e.g., Diffie-Hellman, and a counter. The SK1 and the shared secret do not change after a reboot, but the counter could be changed. Every time the A/V processor 204 increments the counter, a new set of secure tunnel keys has to be re-derived. Accordingly, the communication processor 202 is forced to also re-derive the new set of secure tunnel keys. This updating of the secure tunnel keys is utilized in case the old set of secure tunnels keys is somehow leaked.

Further, the A/V processor 204 may force the communication processor 202 to provide the code version number of the code 214 stored in the communication processor 202 during the secure tunnel establishment. The A/V processor 204 would store the smallest acceptable code version of the code 214 stored in the communication processor 202. Code versions that are too low are generally associated with non-secure code that has one or more security flaws. If the A/V processor 204 finds that the code version of the code 214 stored in the communication processor 202 is too low, the A/V processor 204 rejects the code version, and a secure tunnel is not successfully established.

In either of the configurations illustrated in FIGS. 2A and 2B, the communication processor 202 may also transcode the content already stored on the hard drive 208, which includes decryption and re-encryption of the transcoded content. The A/V processor 204 may be responsible for DRM, local content playback (which includes decryption), and forwarding of content to other devices for remote playback (which involves DRM exchanges with other devices). In addition, the general processor 206 is responsible for content management and proxying of messages between the communication processor 202 and the A/V processor 204.

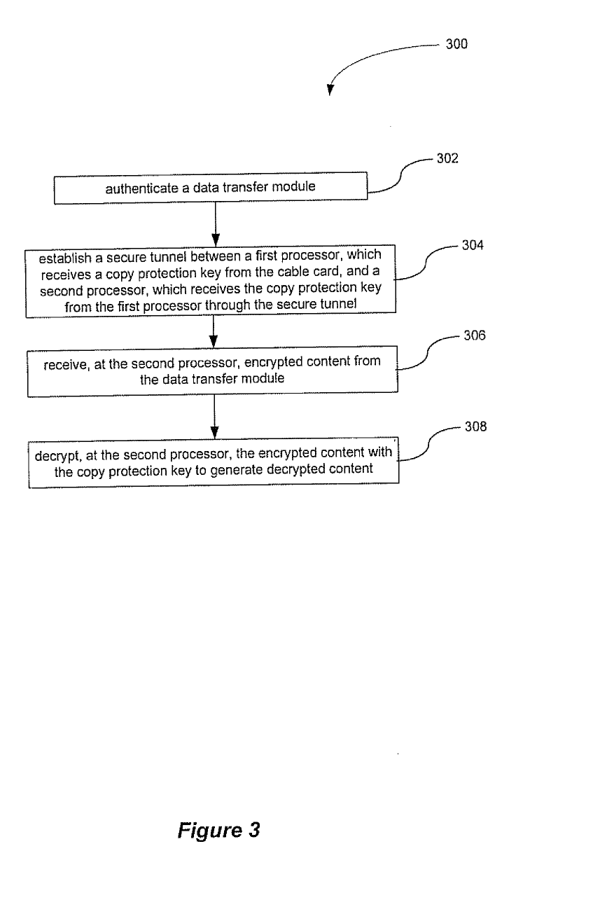

FIG. 3 illustrates a process 300 that enhances the security of the set top box 104 shown in FIG. 1. At a process block 302, the process 300 authenticates a data transfer module 106. Further, at a process block 304, the process 300 establishes a secure tunnel between a first processor, which receives a copy protection key from the data transfer module 106, and a second processor, which receives the copy protection key from the first processor through the secure tunnel. In addition, at a process block 306, the process 300 receives, at the second processor, encrypted content from the data transfer module 106. At a process block 308, the process 300 also decrypts, at the second processor, the encrypted content with the copy protection key to generate decrypted content.

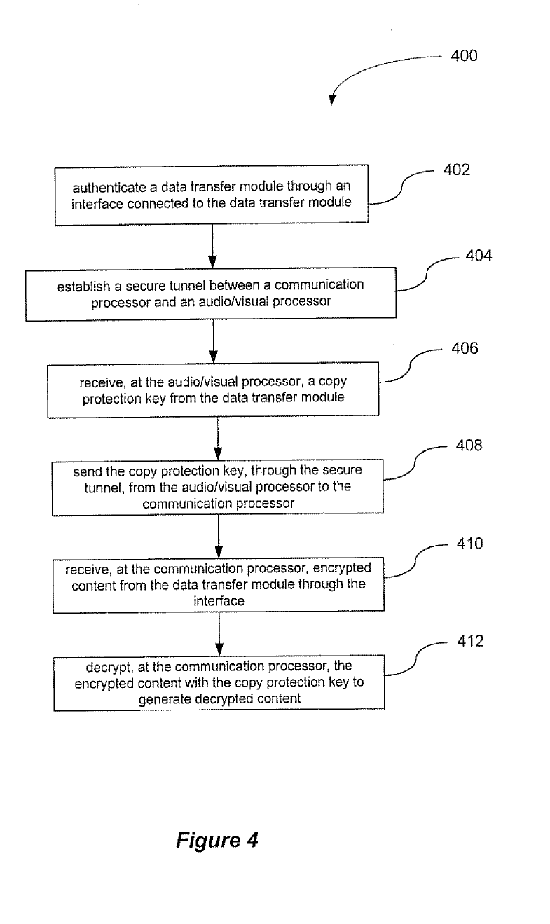

FIG. 4 illustrates another process 400 that enhances the security of the set top box 104 shown in FIG. 1. At a process block 402, the process 400 authenticates a data transfer module 106 through an interface connected to the data transfer module 106. Further, at a process block 404, the process 400 establishes a secure tunnel between a communication processor and an audio/visual processor. In addition, at a process block 406, the process 400 receives, at the audio/visual processor, a copy protection key from the data transfer module 106. At a process block 408, the process 400 sends the copy protection key, through the secure tunnel, from the audio/visual processor to the communication processor. Further, at a process block 410, the process 400 receives, at the communication processor, encrypted content from the data transfer module 106 through the interface. Finally, at a process block 412, the process 400 decrypts, at the communication processor, the encrypted content with the copy protection key to generate decrypted content.

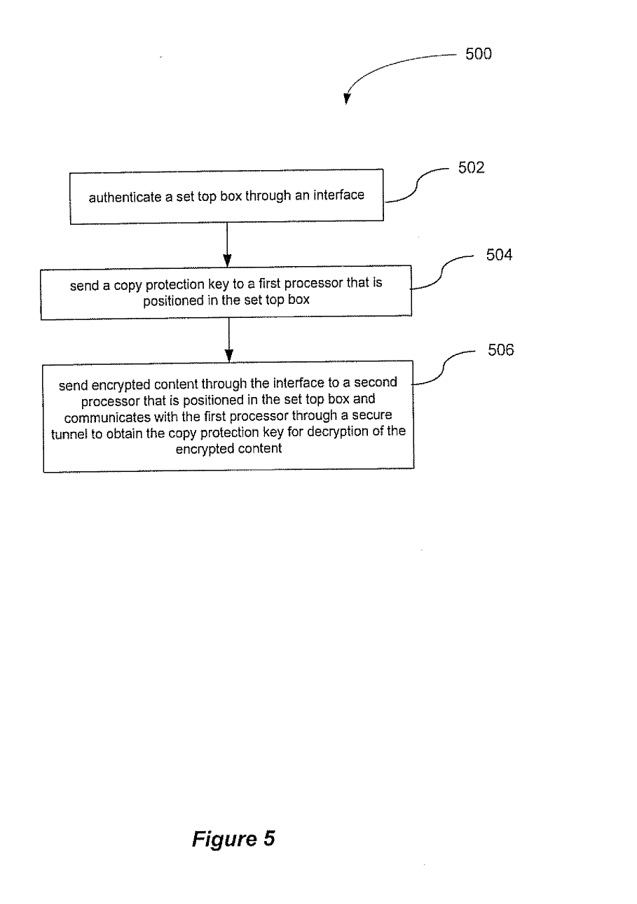

FIG. 5 illustrates a process 500 that enhances the security of the data transfer module 106 that is utilized in conjunction with the set top box 104 shown in FIG. 1. At a process block 502, the process 500 authenticates a set top box through an interface. Further, at a process block 504, the process 500 sends a copy protection key to a first processor that is positioned in the set top box. In addition, at a process block 506, the process 500 sends encrypted content through the interface to a second processor that is positioned in the set top box and communicates with the first processor through a secure tunnel to obtain the copy protection key for decryption of the encrypted content.

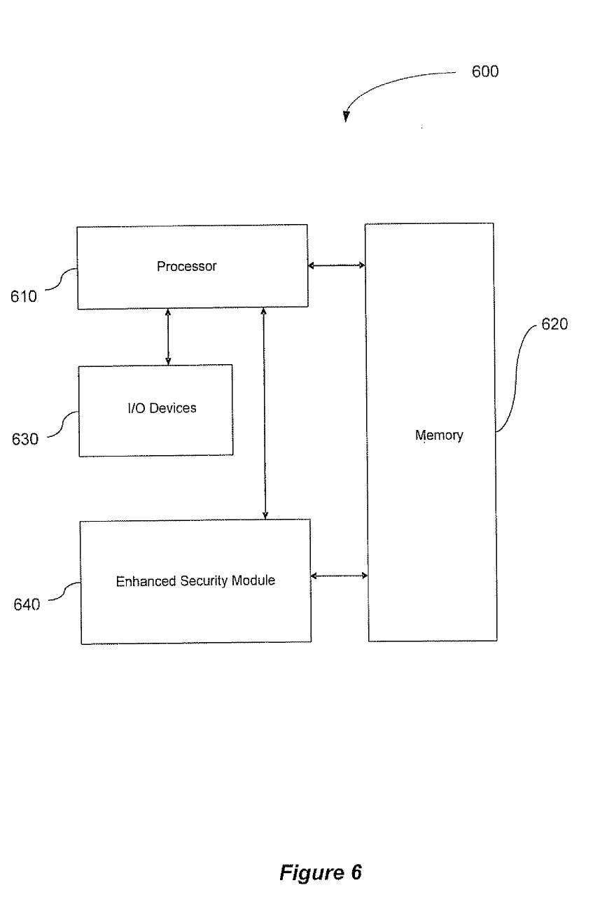

FIG. 6 illustrates a block diagram of a station or system 600 that enhances the security of a set top box. In one embodiment, the station or system 600 is implemented using a general purpose computer or any other hardware equivalents. Thus, the station or system 600 comprises a processor 610, a memory 620, e.g., random access memory (“RAM”) and/or read only memory (ROM), an enhanced security module 640, and various input/output devices 630, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)). The enhanced security module 640 may include one or more processors, e.g., the communication processor 202 and the A/V processor 204, and/or corresponding code.

It should be understood that the enhanced security module 640 may be implemented as one or more physical devices that are coupled to the processor 610 through a communication channel. Alternatively, the enhanced security module 640 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 620 of the computer. As such, the enhanced security module 640 (including associated data structures) of the present disclosure may be stored on a computer readable medium, e.g., RAM memory, magnetic or optical drive or diskette and the like.

It is understood that the enhanced security approach described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. A method comprising:
authenticating a data transfer module;
establishing a secure tunnel between a first processor, which receives a copy protection key from the data transfer module, and a second processor, which receives the copy protection key from the first processor through the secure tunnel;
receiving, at the second processor, encrypted content from the data transfer module; and
decrypting, at the second processor, the encrypted content with the copy protection key to generate decrypted content.

2. The method of claim 1, further comprising receiving an instruction to record the decrypted content on a hard drive associated with a device and re-encrypting the decrypted content with a content key prior to recording the decrypted content on the hard drive.

3. The method of claim 1, wherein the first processor sends a content key to the second processor so that the second through the secure tunnel.

4. The method of claim 3, further comprising re-encrypting the decrypted content at the second processor with the content key prior to streaming the re-encrypted content to the first processor for decryption and rendering on a display.

5. The method of claim 1, wherein the first processor decrypts an encrypted copy protection key to receive the copy protection key from the data transfer module.

6. The method of claim 1, wherein the first processor has a secure memory that stores a session key.

7. The method of claim 6, wherein the first processor stores a global key in the secure memory, and the second processor loads a set of encrypted code that has the global key hard coded in the set of code.

8. The method of claim 7, wherein the second processor decrypts the encrypted code with a code encryption key stored in a secure memory to retrieve the global key in the set of code.

9. The method of claim 8, wherein the establishing the secure tunnel includes generating a secure tunnel key that is derived from the global key and a session key that is stored in one-time programmable memory of the second processor and a secure memory of the first processor.

10. The method of claim 1, wherein the authenticating the data transfer module includes a review by the first processor of a digital certificate associated with the data transfer module.

11. The method of claim 1, wherein the encrypted content is encrypted by the data transfer module with the copy protection key.

12. A method comprising:
authenticating a data transfer module through an interface connected to the data transfer module;
establishing a secure tunnel between a communication processor and an audio/visual processor;
receiving, at the audio/visual processor, a copy protection key from the data transfer module;
sending the copy protection key, through the secure tunnel, from the audio/visual processor to the communication processor;
receiving, at the communication processor, encrypted content from the data transfer module through the interface; and
decrypting, at the communication processor, the encrypted content with the copy protection key to generate decrypted content.

13. The method of claim 12, wherein the audio/visual processor sends a content key to the communication processor through the secure tunnel.

14. The method of claim 13, further comprising receiving an instruction to record the decrypted content on a hard drive associated with the device and re-encrypting the decrypted content with a content key prior to recording the decrypted content on the hard drive.

15. The method of claim 12, further comprising re-encrypting the decrypted content at the communication processor prior to streaming the re-encrypted content to the audio/visual processor for decryption and rendering on a display.

16. The method of claim 12, wherein the audio/visual processor includes a trusted environment.

17. The method of claim 16, wherein the audio/visual processor has a secure memory that stores a session key.

18. The method of claim 12, wherein the authenticating the data transfer module includes a review by the audio/visual processor of a digital certificate associated with the data transfer module.

19. A method comprising:
authenticating a device through an interface;
sending a copy protection key to a first processor that is positioned in the device; and
sending encrypted content through the interface to a second processor that is positioned in the device and communicates with the first processor through a secure tunnel to obtain the copy protection key for decryption of the encrypted content.

20. The method of claim 19, wherein the authenticating includes a review of a digital certificate associated with the device.
